(19) United States
(12) Patent Application Publication
(10) Pub. No.: US 2017/0060390 A1
(43) Pub. Date: Mar. 2, 2017

(54) CONTROL METHOD AND CONTROL DEVICE

(71) Applicant: FUJITSU LIMITED, Kawasaki-shi (JP)

(72) Inventor: Hitoshi Hashimoto, Kawasaki (JP)

(73) Assignee: FUJITSU LIMITED, Kawasaki-shi (JP)

(21) Appl. No.: 15/186,405

(22) Filed: Jun. 17, 2016

(30) Foreign Application Priority Data
Sep. 2, 2015 (JP) 2015-173203

(51) Int. Cl. G06F 3/0484; G06F 17/24; G06F 3/0481

(52) U.S. Cl. CPC G06F 3/04845; G06F 3/0481; G06F 17/241; G06F 2203/04804

(57) ABSTRACT

A control method executed by a computer includes, while a sticky screen displayed on a desktop screen and for leaving at least one of a comment and a drawing on the desktop is not being edited, displaying the sticky screen transparently, displaying the sticky screen in a rearmost layer behind at least one window screen displayed on the desktop screen, the sticky screen being transparently displayed, and when a first operation for a display region in which the sticky screen is displayed is detected, receiving information about the first operation as an operational instruction for the desktop screen corresponding to the display region.

### CROSS-REFERENCE TO RELATED APPLICATION

This application is based upon and claims the benefit of priority of the prior Japanese Patent Application No. 2015-173203, filed on Sep. 2, 2015, the entire contents of which are incorporated herein by reference.

### FIELD

The embodiments discussed herein are related to display control.

### BACKGROUND

In paperwork in a company or an office, to leave a simple memo, a simple message or piece of information may be written in a piece of paper called a sticky and may be stored with documents. Recently, to improve usability of information processing devices such as a personal computer (PC), information processing devices in which a function of displaying an electronic sticky (sticky application) is implemented have been developed (for example, see Japanese Laid-open Patent Publication No. 2007-317212).

### SUMMARY

According to an aspect of the invention, a control method executed by a computer includes, while a sticky screen displayed on a desktop screen and for leaving at least one of a comment and a drawing on the desktop is not being edited, displaying the sticky screen transparently, displaying the sticky screen in a rearmost layer behind at least one window screen displayed on the desktop screen, the sticky screen being transparently displayed, and when a first operation for a display region in which the sticky screen is displayed is detected, receiving information about the first operation as an operational instruction for the desktop screen corresponding to the display region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram which schematically illustrates the hardware configuration of an information processing device according to a first embodiment.

FIG. 2 is a diagram illustrating programs stored in an HDD and functions of a sticky application.

FIG. 3 is a flowchart illustrating a process of the sticky application.

FIG. 4 is a flowchart illustrating a specific process in step S28 in FIG. 3.

FIGS. 5A and 5B are diagrams illustrating exemplary displays of sticky-application screens.

FIGS. 6A and 6B are diagrams illustrating exemplary input to sticky-application screens.

FIG. 7 is a diagram illustrating a data flow among an OS, a driver utility, and the sticky application in the edit mode.

FIG. 8 is a (first) diagram for describing switching from the edit mode to the fixing mode.

FIGS. 9A and 9B are (second) diagrams for describing switching from the edit mode to the fixing mode.

FIG. 10 is a diagram illustrating a flow of messages and data among the OS, the driver utility, and the sticky application in the fixing mode.

FIG. 11 is a diagram illustrating exemplary data held by the OS, the driver utility, and the sticky application.

FIGS. 12A and 12B are diagrams for describing an operation of creating an association.

FIGS. 13A and 13B are diagrams illustrating a move of a sticky-application screen which is made when an associated icon is moved.

FIGS. 14A and 14B are diagrams illustrating an example obtained when characters which are input in a sticky-application screen having been moved overlap other icons.

FIG. 15 is a diagram illustrating exemplary use obtained when a sticky-application screen is displayed over the entire screen.

FIG. 16 is a diagram illustrating an example obtained when multiple sticky-application screens are used in such a manner as to overlap one another.

FIG. 17 is a flowchart illustrating a process in the fixing mode (S28) according to a second embodiment.

FIG. 18 is a diagram illustrating exemplary data held by the OS, the driver utility, and the sticky application according to the second embodiment.

FIG. 19 is a diagram illustrating a flow of messages and data among the OS, the driver utility, and the sticky application in the fixing mode, according to the second embodiment.

FIG. 20 is a flowchart illustrating a process of a processor according to a third embodiment.

FIG. 21 is a flowchart illustrating a specific process in step S28 in FIG. 20.

FIG. 22 is a flowchart illustrating a process of the OS according to the third embodiment.

FIG. 23 is a diagram illustrating a flow of messages and data among the OS, the driver utility, and the sticky application in the fixing mode according to the third embodiment.

### DESCRIPTION OF EMBODIMENTS

A sticky application on the desktop screen is convenient to leave a memo or the like about icons on the desktop screen as well as a memo describing a schedule, a note, or the like for a user.

However, when a sticky application is present on the desktop screen, the sticky application may obstruct an operation on the desktop screen (for example, selection of an icon), resulting in reduction in usability.

In one aspect, an object of the present disclosure is to provide a technique for user-friendly screen display.

### First Embodiment

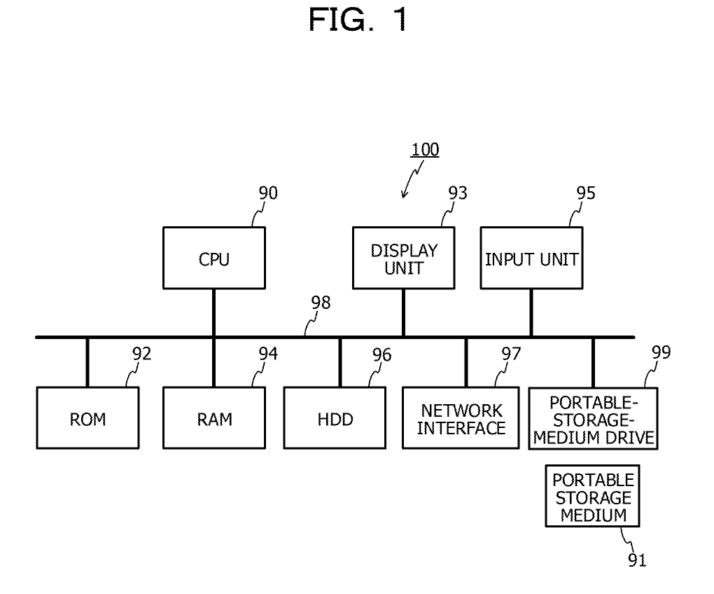

A first embodiment of an information processing device will be described below in detail based on FIGS. 1 to 13B. FIG. 1 illustrates the hardware configuration of an information processing device 100 serving as a screen display device and a processing device according to the first embodiment.

As illustrated in FIG. 1, the information processing device 100 includes a central processing unit (CPU) 90, a read only memory (ROM) 92, a random access memory (RAM) 94, a storage unit (herein a hard disk drive (HDD)) 96, a network interface 97, a display unit 93, an input unit 95, and a portable-storage-medium drive 99. The units included in the information processing device 100 are connected to a bus 98. The display unit 93 includes a liquid-crystal display, and the input unit 95 includes a keyboard and mouse, and a touch panel.

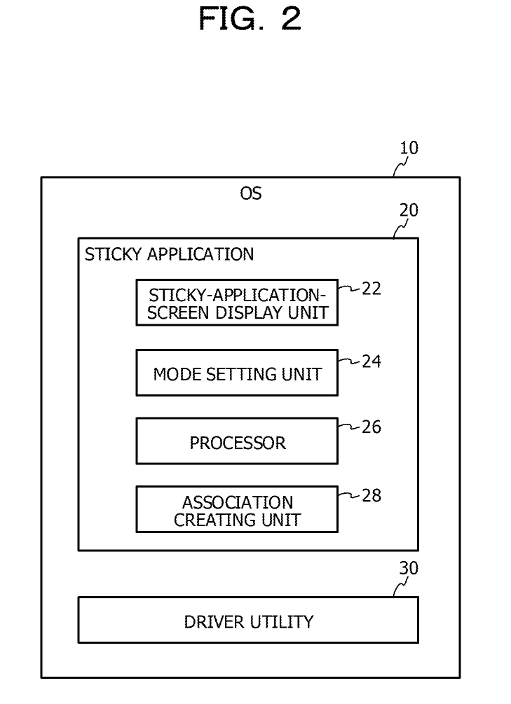

The HDD 96 stores an operating system (OS) 10 and a driver utility software 30 (hereinafter described as a driver utility 30) which are illustrated in FIG. 2, application programs, data which is used by the CPU 90 performing processing, and the like. The OS 10 is Windows (registered trademark) or the like, and the driver utility 30 has a function of obtaining information which is input by a user via the input unit 95 and transmitting the information to the OS 10.

The application programs include a sticky application 20 serving as a screen display program. For example, the sticky application 20 is read out from a portable storage medium 91 by using the portable-storage-medium drive 99, and is transferred to the HDD 96. As illustrated in FIG. 2, the sticky application 20 functions as a sticky-application-screen display unit 22, a mode setting unit 24, a processor 26, and an association creating unit 28. The sticky application 20 includes a parent application and child applications. The parent application operates in the background all the time, and manages the child applications. Each of the child applications indicates a corresponding one of sticky-application screens which are newly activated.

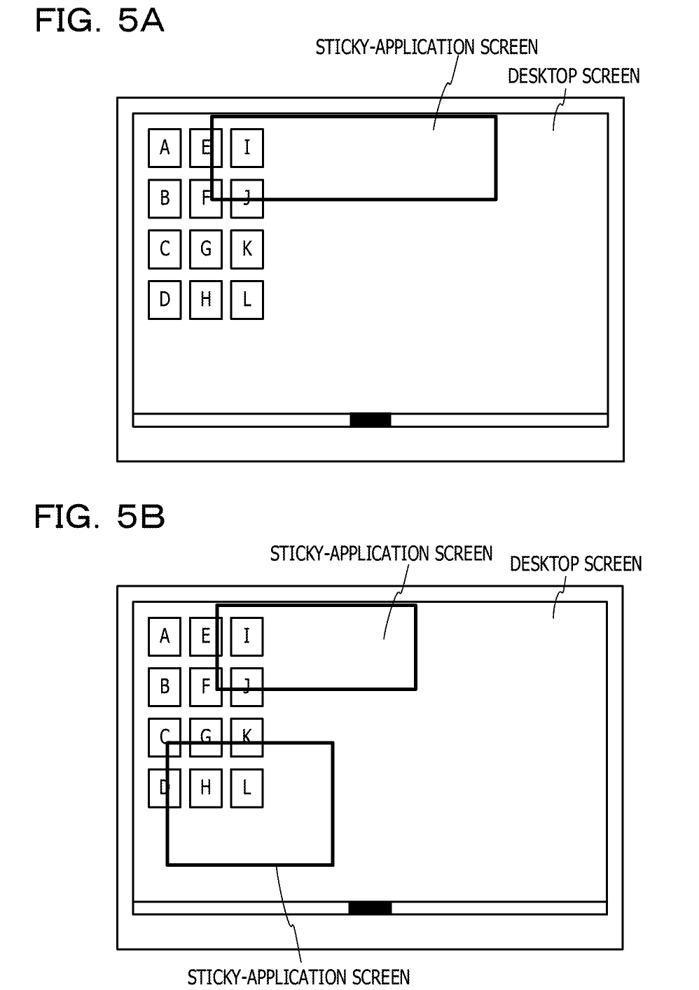

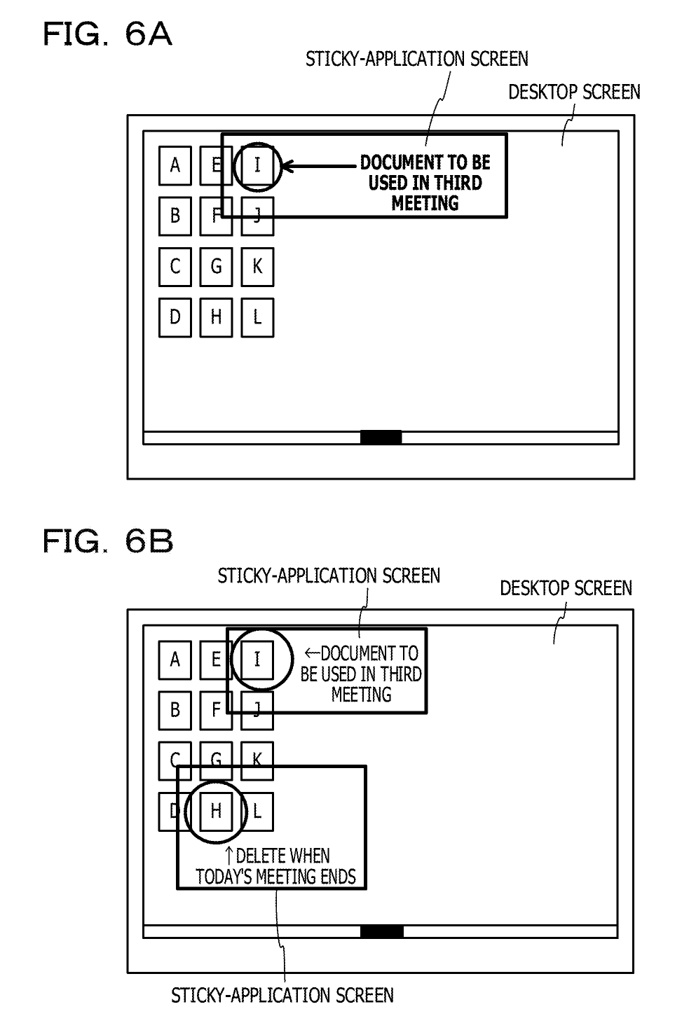

The functions of the sticky application 20 will be described. The sticky-application-screen display unit 22 displays a write screen (hereinafter referred as a “sticky-application screen”) for leaving a memo or the like on the desktop screen, on the desktop screen as illustrated in FIGS. 5A to 6B and the like. In the present embodiment, as illustrated in FIG. 5A and the like, icons for activating programs and icons of files and folders (A to L) are present on the desktop screen.

The mode setting unit 24 switches between the edit mode and the fixing mode in accordance with a user input. The edit mode is a mode in which operations, such as input of characters and drawing of figures to a sticky-application screen, moving and scaling-up or scaling-down of a sticky-application screen, and an operation for creating an association which is described below, may be performed. The fixing mode is a mode in which sticky-application screens are disposed in the rearmost layer behind the other window screens, and in which no operations for the sticky-application screens are accepted. When multiple sticky-application screens are activated, the mode setting unit 24 collectively manages the modes of the multiple application screens.

When an operational instruction (such as a double click or a right click) is received from a user on a sticky-application screen, the processor 26 performs a process according to the operational instruction. For example, when the edit mode is set, the processor 26 handles the operational instruction as one for the sticky-application screen. In contrast, when the fixing mode is set, the processor 26 disposes the sticky-application screen in the rearmost layer behind the other window screens, and makes the background fully transparent so that an operational instruction on the sticky-application screen is accepted not as an instruction for the sticky-application screen. When multiple sticky-application screens are displayed, the processor 26 collectively controls the processes for the multiple sticky-application screens.

The association creating unit 28 associates a sticky-application screen with an operational member (such as an icon) on the desktop screen in accordance with a user input. When multiple sticky-application screens are displayed, the association creating unit 28 performs an association creating process for each of the sticky-application screens.

<About Process>

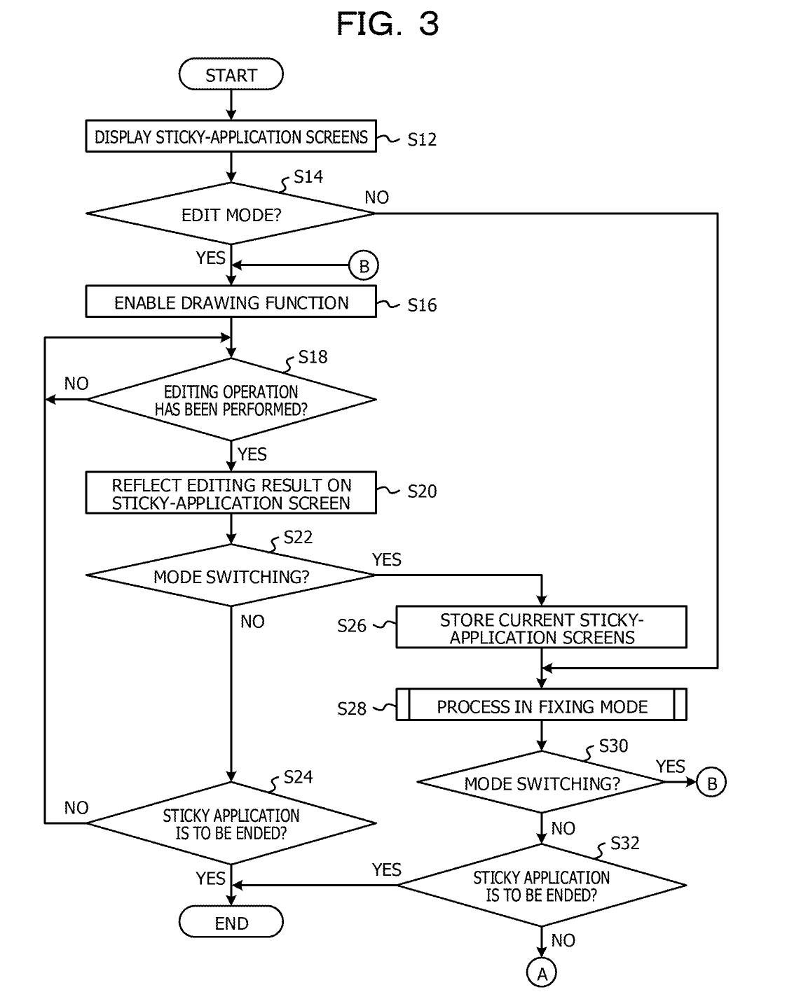

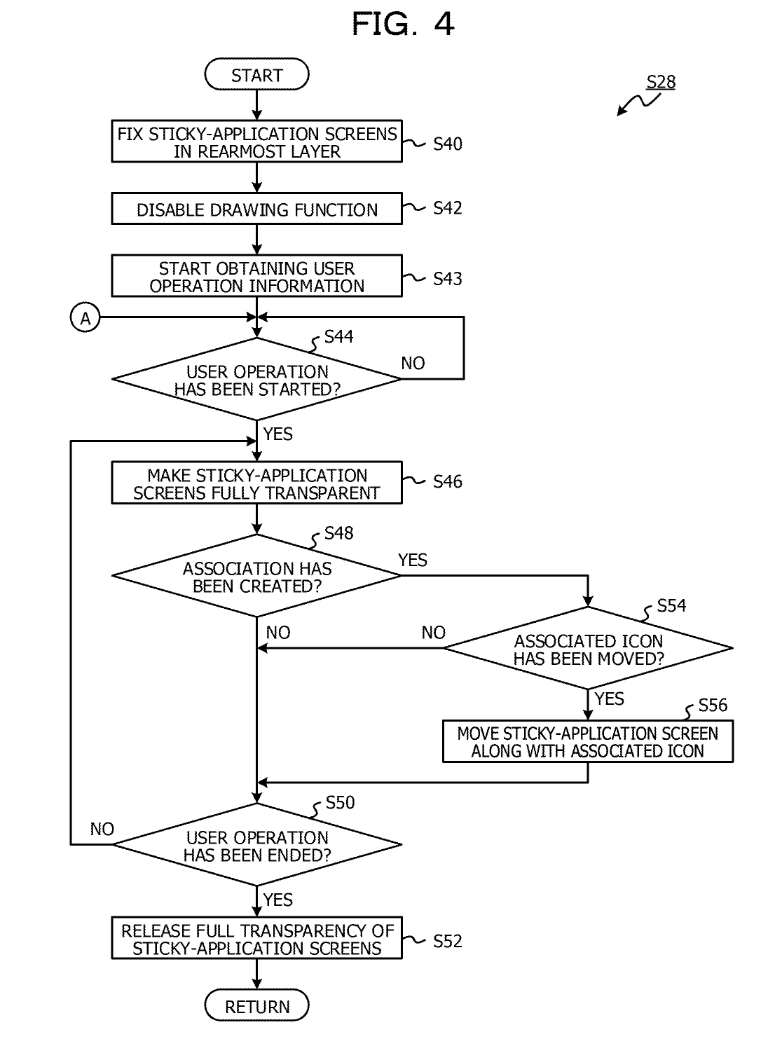

A process of the information processing device 100 according to the first embodiment will be described below in detail according to the flowcharts in FIGS. 3 and 4 by referring to other drawings appropriately.

FIG. 3 illustrates a process of the sticky application 20 in the form of a flowchart. FIG. 4 illustrates a specific process in step S28 in FIG. 3. The process in FIG. 3 is started in the stage in which a user inputs, to the input unit 95, an instruction to activate the sticky application 20.

In the process in FIG. 3, in step S12, the sticky-application-screen display unit 22 first displays sticky-application screens. For example, the sticky-application-screen display unit 22 displays sticky-application screens at predetermined positions on the desktop screen. In this case, when one sticky-application screen is displayed, as illustrated in FIG. 5A, the sticky-application screen may be displayed in such a manner as to cover a part of the desktop screen, or may be displayed in such a manner as to cover the entire desktop screen. When multiple sticky-application screens are displayed, as illustrated in FIG. 5B, the sticky-application screens are displayed at predetermined positions on the desktop screen. In this case, the backgrounds of the sticky-application screens are translucently displayed so that the user may roughly recognize the desktop screen and the positions of icons on the backgrounds of the sticky-application screens. When the sticky application 20 is activated, the user has selected either of the edit mode and the fixing mode. In the description below, assume that the user has selected the edit mode.

In step S14, the mode setting unit 24 determines whether or not the edit mode has been set. If the determination result in step S14 is positive, the process proceeds to step S16, and the processor 26 sets a drawing function enabled. That is, drawing and input of characters which are performed by the user on a sticky-application screen by using the input unit 95 (such as a mouse and keyboard) may be accepted.

In step S18, the processor 26 waits until the user performs an editing operation. An editing operation means an operation of moving or scaling up/down a sticky-application screen, input of characters or drawing of a figure on a sticky-application screen, an operation of creating an association, or the like. In the stage in which the user inputs an editing operation via the input unit 95, the processor 26 causes the process to proceed to step S20.

When the process proceeds to step S20, the processor 26 reflects the editing result on the sticky-application screen. For example, as illustrated in FIGS. 6A and 6B, the processor 26 moves or scales up/down a sticky-application screen based on the operation. In addition, the processor 26 inputs characters or draws a figure on a sticky-application screen based on the operation. Further, the processor 26 also associates a sticky-application screen with an icon on the desktop screen based on the operation. The operation of creating an association will be described below in detail.

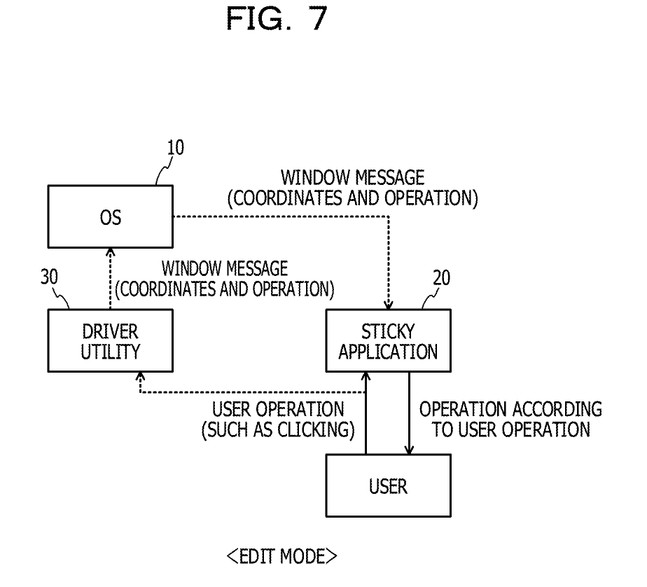

In the edit mode, data is practically transmitted as illustrated in FIG. 7. Specifically, when the driver utility 30 recognizes that the user has performed an operation by using the input unit 95, the driver utility 30 transmits a window message (coordinates and operation) to the OS 10. For example, when the user left-clicks on a sticky-application screen, the driver utility 30 transmits a window message WM_LBUTTONDOWN to the OS 10.

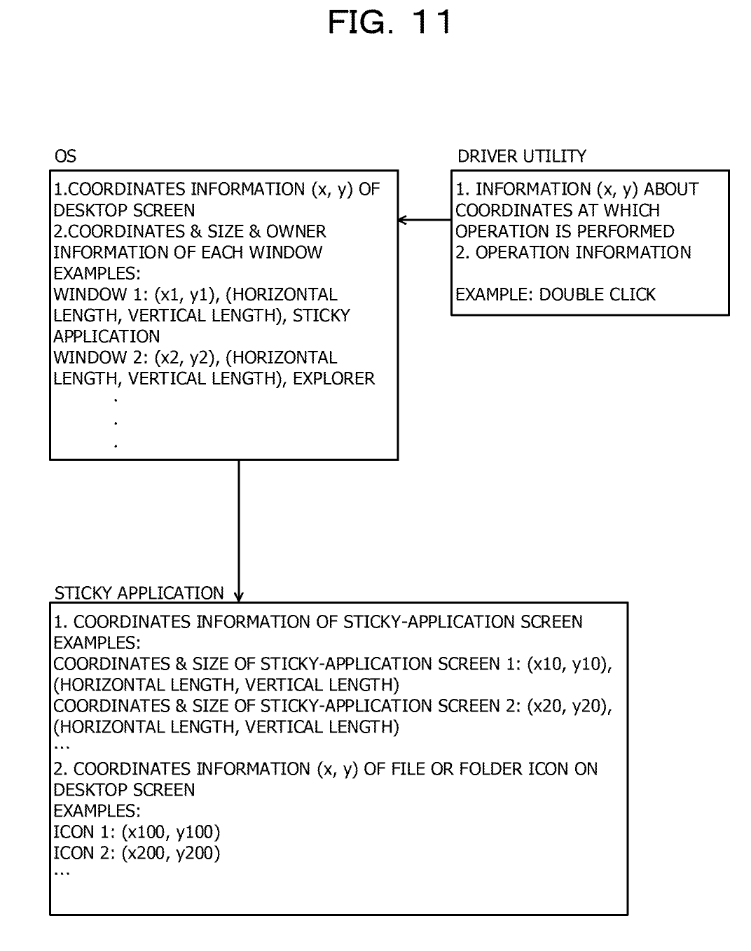

As illustrated in FIG. 11, the OS 10 recognizes coordinates information on the desktop screen as screen coordinates. In this case, the OS 10 recognizes, for example, the coordinates (x, y) of the upper left end of the desktop screen as (0, 0), the right direction as the positive side of the x axis, and the down direction as the positive side of the y axis. The OS 10 manages the position and size of each application window screen or each icon as information indicating the upper left coordinates (x, y), the width (horizontal length), and the height (vertical length). Therefore, in the first embodiment, when the OS 10 obtains, from the driver utility 30, the coordinates of a position at which an operation is performed on the desktop screen, the OS 10 is capable of determining whether or not the operation has been performed on an application window screen.

The OS 10 (desktop window manager (DWM)) specifies, from the window message, an application which is being operated by the user, and puts information about the coordinates and operation which is included in the received window message, in the message queue of the specified application. After that, the sticky application 20 (processor 26) executes the GetMessage( ) function, and obtains information about the window message (coordinates and operation). Then, the sticky application 20 (processor 26) transmits the information about the window message to the window procedure by using the DispatchMessage function, and performs a process (a reflection process on the sticky-application screen) based on the window message.

Referring back to FIG. 3, in the next step S22, the mode setting unit 24 determines whether or not mode switching has been performed. If the determination result is negative, the process proceeds to step S24, and the processor 26 determines whether or not the user has input an instruction to end the sticky application. If the determination result in step S24 is negative, the process returns back to step S18. If the determination result is positive, the entire process in FIG. 3 ends.

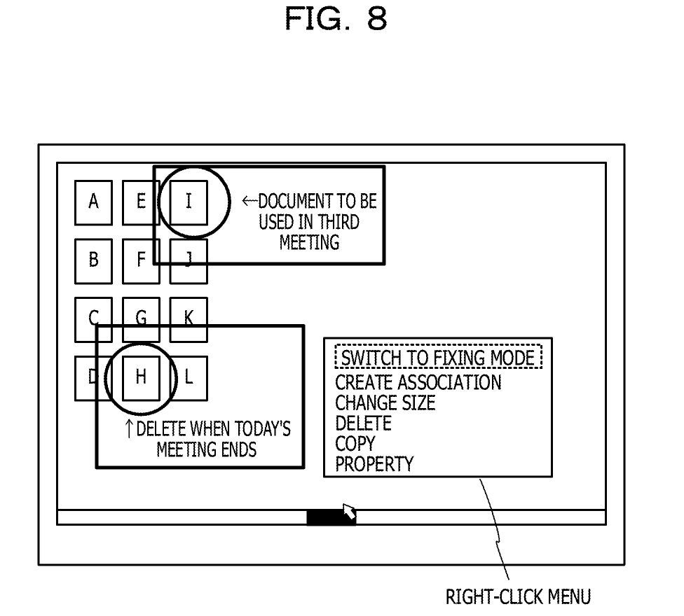

If the determination result in step S22 is positive, that is, if the mode setting unit 24 receives information about mode switching (from the edit mode to the fixing mode) from the user, the process proceeds to step S26. In step S26, the processor 26 stores the current sticky-application screens. When the user performs a mode switching operation, for example, as illustrated in FIG. 8, the user performs right-clicking or the like on the task bar disposed in a portion of the screen (for example, the black portion illustrated in a central lower portion of the screen in FIG. 8), whereby a menu screen (right-click menu) is displayed. Then, the user selects “SWITCH TO FIXING MODE” from the right-click menu.

In step S28, the processor 26 executes a subroutine for the process in the fixing mode. Specifically, the processor 26 performs the process according to the flowchart in FIG. 4.

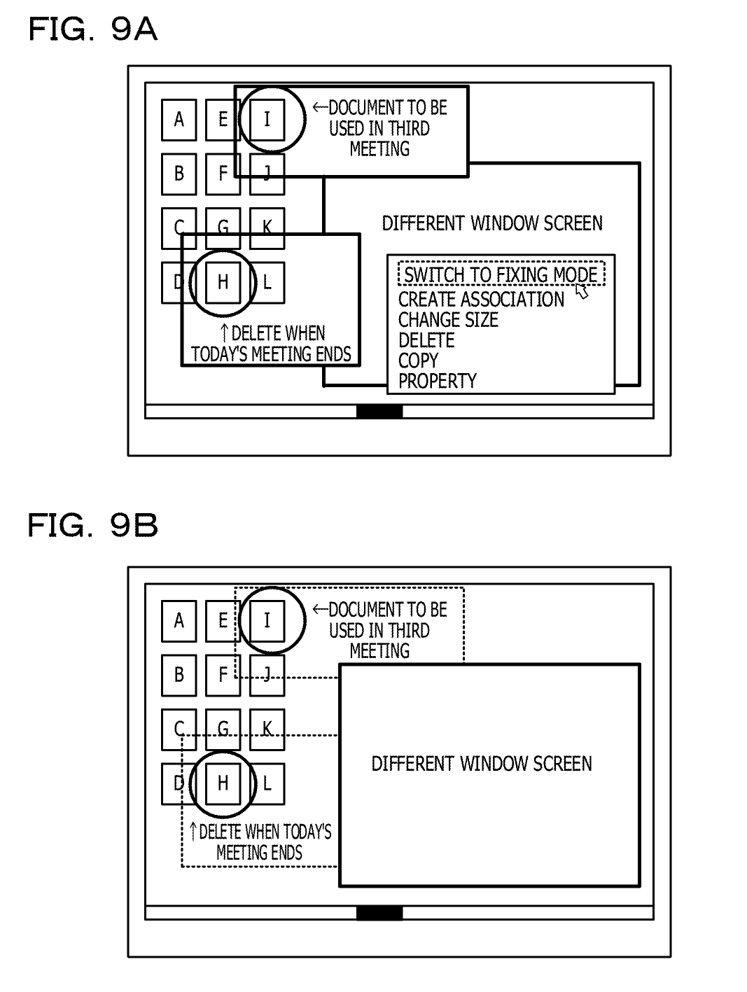

In step S40 in FIG. 4, the processor 26 fixes the sticky-application screens in the rearmost layer. For example, as illustrated in FIG. 9A, assume that switching to the fixing mode is performed when multiple sticky-application screens and a different window screen are present on the desktop screen. In this case, as illustrated in FIG. 9B, the processor 26 disposes the multiple sticky-application screens in the rearmost layer behind the different window screen (just on the desktop screen), and fixes the sticky-application screens. In this state, for example, even when the user clicks on a sticky-application screen, the sticky-application screen is not activated. That is, the sticky-application screens are not allowed to be pushed to the front of the different window screen.

In step S42, the processor 26 disables the drawing function. In step S43, the processor 26 starts obtaining user operation information.

In step S44, the processor 26 waits until a user operation is started. In the stage in which the processor 26 recognizes that a user operation has been started, the process proceeds to step S46.

When the process proceeds to step S46, the processor 26 makes the sticky-application screens fully transparent. Full transparency means that a layered window is used to make a screen fully transparent (alpha value=0). For example, the processor 26 provides an extended attribute (WS_EX_LAYERED) to each of the sticky-application screens by using the SetWindowLong function, and sets the sticky-application screen fully transparent (alpha value=0) by using the SetLayeredWindowAttributes function. Thus, the sticky-application screen does not accept an operation from the user. Therefore, the user may operate an icon or the like which is present on the background of the sticky-application screen.

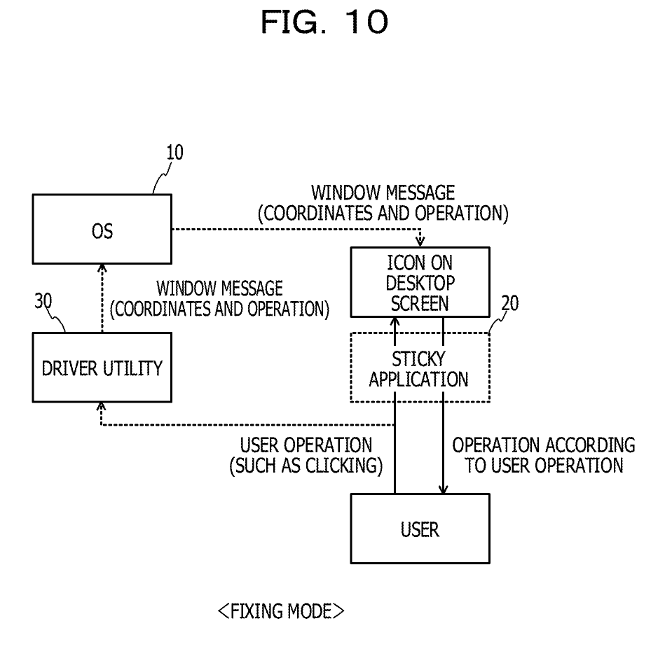

In the fixing mode, as illustrated in FIG. 10, when the user operates an icon which is present on the desktop, on a sticky-application screen, the driver utility 30 recognizes the user operation, and transmits a window message (coordinates and operation) to the OS 10. The OS 10 performs a process (such as a process of opening a file or a folder, or a process of executing a program) on the icon on the desktop screen based on the window message (coordinates and operation).

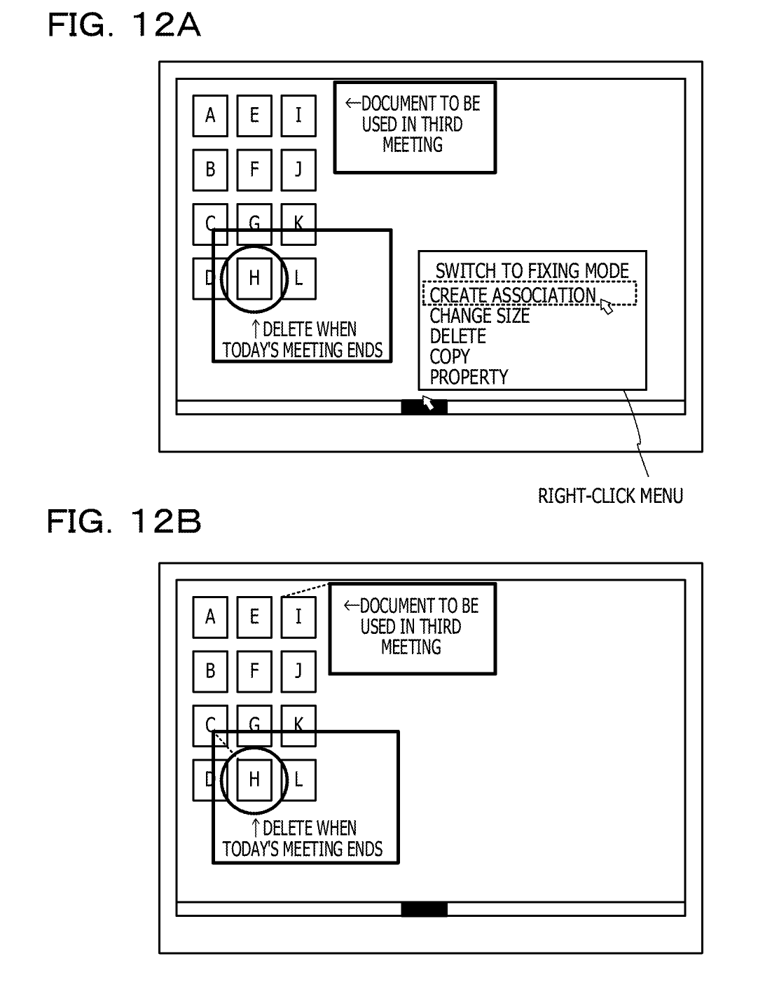

Referring back to FIG. 4, in the next step S48, the processor 26 determines whether or not an association has been created. An operation of creating an association may be performed when the sticky application 20 is set to the edit mode, as described above. Specifically, as illustrated in FIG. 12A, the user displays the right-click menu, selects “CREATE ASSOCIATION” from the right-click menu, and clicks a file or folder icon and a sticky-application screen which is to be associated with the icon. When the association creating unit 28 receives this operation, the association creating unit 28 stores information indicating that the icon and the sticky-application screen which are clicked are associated with each other. In this case, in the sticky application, as illustrated in FIG. 11, the coordinates and size of the sticky-application screen are stored as coordinates information of the sticky-application screen, and coordinates information of the icon on the desktop is also stored. Therefore, when an operation of creating an association is performed as described above, information indicating that a sticky-application screen and an icon are associated with each other is stored. FIG. 12B illustrates a state in which the icon “I” and a sticky-application screen which is present on the upper side are associated with each other, and in which the icon “H” and a sticky-application screen which is present on the lower side are associated with each other. In FIG. 12B, an icon and a sticky-application screen which are associated with each other are connected to each other with a dashed line. Actually, the dashed line may be invisible.

If the determination result in step S48 is negative, that is, if an association has not been created, the process proceeds to step S50, and the processor 26 determines whether or not the user operation has been ended. If the determination result in step S50 is negative, the process returns back to step S46. If the determination result in step S50 is positive, the process proceeds to step S52. When the process proceeds to step S52, the processor 26 releases full transparency of the windows.

In the first embodiment, only during a user operation, the sticky-application screens may be made fully transparent. This is because, when the background is transparent, a text memo or the like which is input to a sticky-application screen may be difficult to read depending on the pattern of the desktop screen. That is, for example, making the background of a sticky-application screen white causes the text to be easy to read. To make an icon or the like behind a sticky-application screen easy to view during a user operation in the fixing mode, the sticky-application screen is made fully transparent. Thus, the usability may be improved. However, this is not limiting, and the sticky-application screen may be transparent for the period in which the fixing mode is set.

In contrast, if the determination result in step S48 is positive, that is, if an association has been already created, the processor 26 causes the process to proceed to step S54. In step S54, the processor 26 determines whether or not information about the user operation which has been input from the input unit 95 indicates a move of an associated icon.

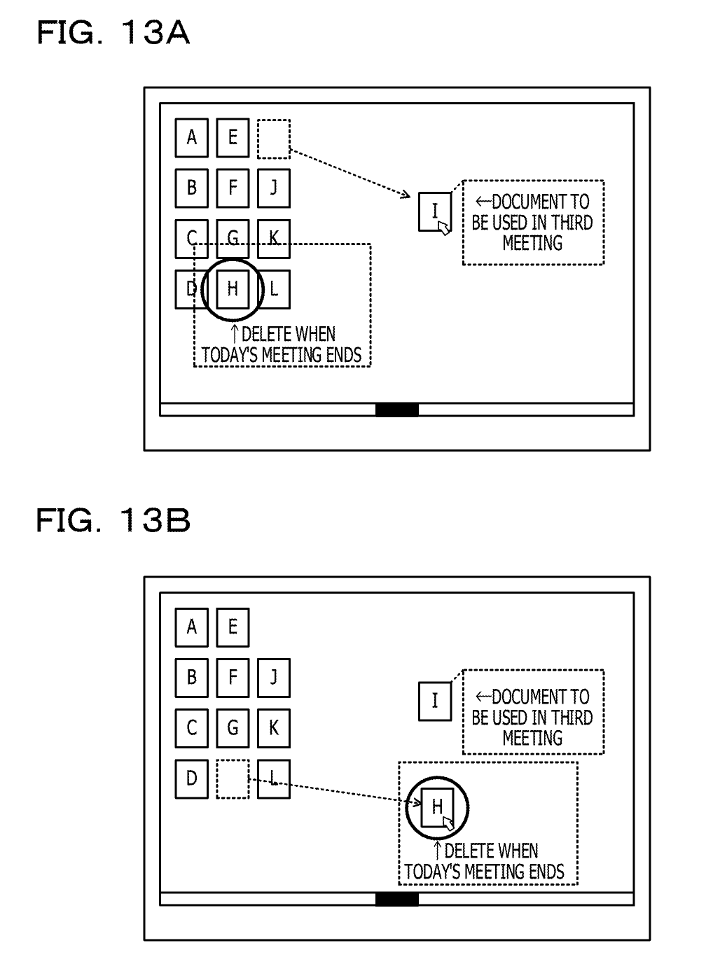

If the determination result in step S54 is negative, the processor 26 causes the process to proceed to step S50. In contrast, if the determination result in step S54 is positive, the process proceeds to step S56, and the processor 26 moves the sticky-application screen along with the associated file or folder icon. For example, as illustrated in FIG. 13A, when the OS 10 moves the icon “I” in accordance with a user operation, the sticky-application screen associated with the icon “I” is moved by the processor 26 in the same direction and by the same distance as is the icon “I”. As illustrated in FIG. 13B, when the OS 10 moves the icon “H” in accordance with a user operation, the sticky-application screen associated with the icon “H” is also moved by the processor 26 in the same direction and by the same distance as is the icon “H”.

After that, the process proceeds to step S50, and the process after step S50 is performed in a similar way as described above. After the process in step S52 is performed, the processor 26 causes the process to proceed to step S30 in FIG. 3.

When the process proceeds to step S30, the mode setting unit 24 determines whether or not mode switching has been performed. If the determination result in step S30 is positive, the process returns back to step S16. In contrast, if the determination result in step S30 is negative, the process proceeds to step S32, and the sticky-application-screen display unit 22 determines whether or not the user has transmitted an instruction to end the sticky application. If the determination result in step S32 is negative, the process proceeds to step S44 in FIG. 4, and the processes after step S44 are performed in a similar way as described above. If the determination result in step S32 is positive, the entire process in FIG. 3 ends. When the sticky application is ended, the sticky-application screens which have been created may be stored. In the case where the sticky-application screens are stored, the sticky-application screens may be invoked when the sticky application is activated after that. In this case, the fixing mode may be set from a time point at which the sticky application is activated. In this case, the determination result in step S14 in FIG. 3 is negative, and the process proceeds to step S28. The processes after step S28 as described above are performed.

The first embodiment achieves a function as a display unit which includes the sticky-application-screen display unit 22 and the processor 26 and which displays sticky-application screens through which the desktop screen is transparently viewed, in the rearmost layer behind the other window screens when the sticky-application screens are not being edited. The first embodiment also achieves a function as a receiving unit which includes the processor 26 and which does not receive an operation on a write screen as an operation for the write screen in the fixing mode and receives an operation on the write screen as an operation for the write screen in the edit mode.

As described above in detail, in the first embodiment, the processor 26 displays sticky-application screens through which the desktop screen is transparently viewed, in the rearmost layer behind the other window screens except in the edit mode (in the fixing mode) (S40). The processor 26 does not receive an operation on a sticky-application screen as an operation for the sticky-application screen in the fixing mode (S46), and the OS 10 performs a process on the desktop screen in accordance with the operation. In contrast, in the edit mode, an operation on the sticky-application screen is received as an operation for the sticky-application screen (S20). Thus, in the edit mode, input of characters and drawing of a figure on a sticky-application screen enable a memo or an arrangement for the desktop screen to be made, enabling the usability to be improved. In the fixing mode, an operation on an icon or the like is allowed to be performed on a sticky-application screen. Therefore, an operation on an icon or the like may be easily performed without being obstructed by sticky-application screens. Thus, work, such as clicking or dragging of an icon on the desktop screen, may be unaffected by sticky-application screens, enabling the usability to be improved.

In the present embodiment, multiple sticky-application screens may be displayed on the desktop screen. Thus, multiple memos may be left on respective sticky-application screens, enabling a memo, for example, to be easily added or deleted.

In the present embodiment, in the case where the association creating unit 28 has received an operation of associating a sticky-application screen with an icon on the desktop screen, when the OS 10 moves the icon on the desktop screen, the processor 26 moves the sticky-application screen associated with the moved icon, along with the icon (S56). Thus, a memo left in association with the icon may be moved in accordance with the move of the icon, enabling the usability to be improved.

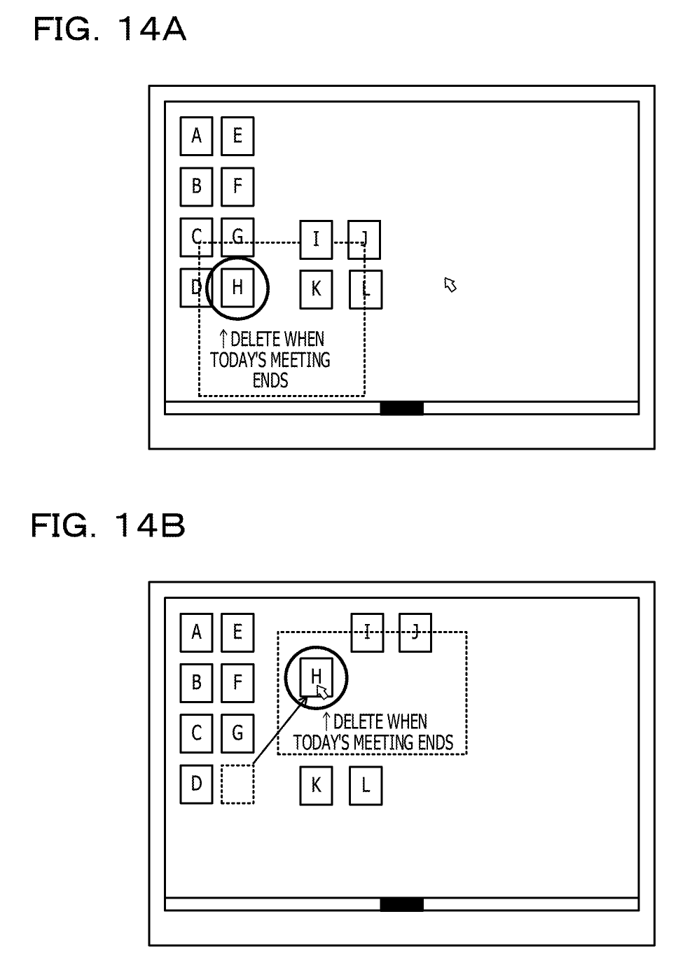

In the first embodiment, in the case where icons and a sticky-application screen are disposed as illustrated in FIG. 14A, and where the icon “H” and the sticky-application screen are associated with each other, assume that the icon “H” is moved to the position illustrated in FIG. 14B. In this case, as illustrated in FIG. 14B, icons (“I” and “J”) which overlap input characters or a drawn figure on the sticky-application screen may be moved to a position at which the icons do not overlap the characters or the figure. In this case, the processor 26 recognizes the position of the characters or the figure in the form of coordinates. When the processor 26 determines that the coordinates of the characters or the figure and the coordinates of the icon cause overlapping, the processor 26 may instruct the OS 10 to move the target icon based on a predetermined rule. If the move destination position is such that an icon does not overlap the characters or the figure, the icon may be present behind the sticky-application screen.

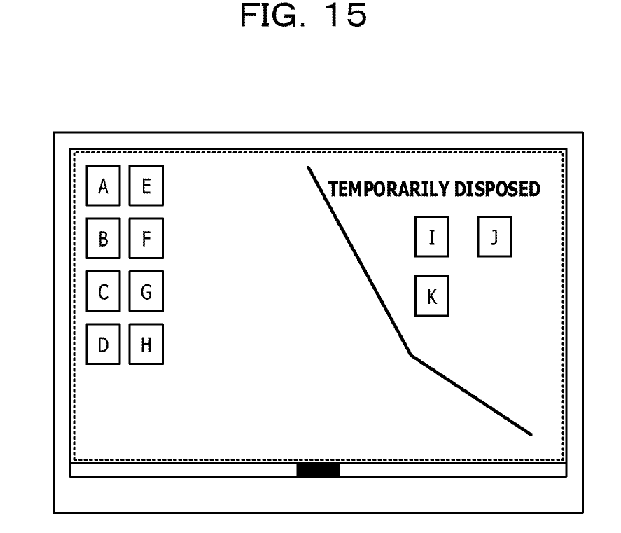

In the first embodiment, when a sticky-application screen is displayed over the entire screen, the sticky-application screen may be used to divide the desktop screen as illustrated in FIG. 15 into multiple regions. Such use of the sticky-application screen enables icons on the desktop screen to be organized, and enables icons, for example, to be more easily found.

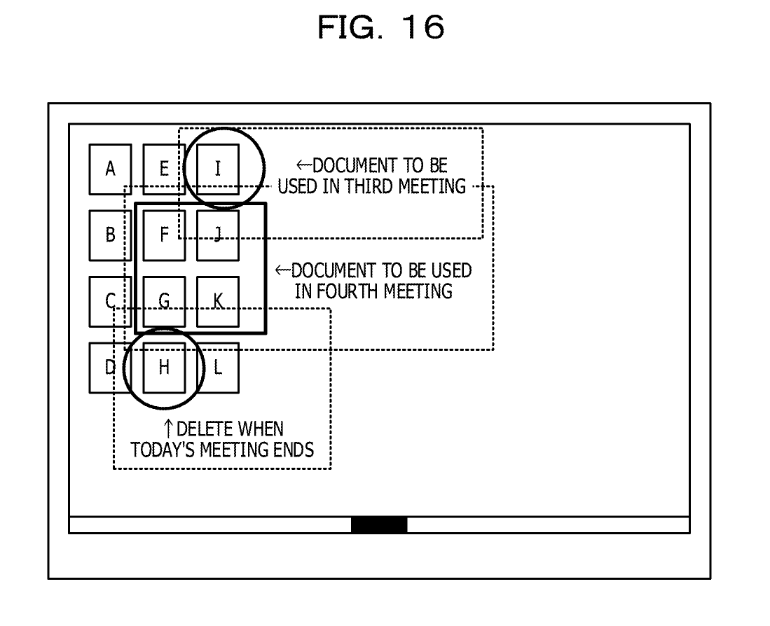

In the first embodiment, as illustrated in FIG. 16, sticky-application screens may be disposed in such a manner as to overlap one another.

### Second Embodiment

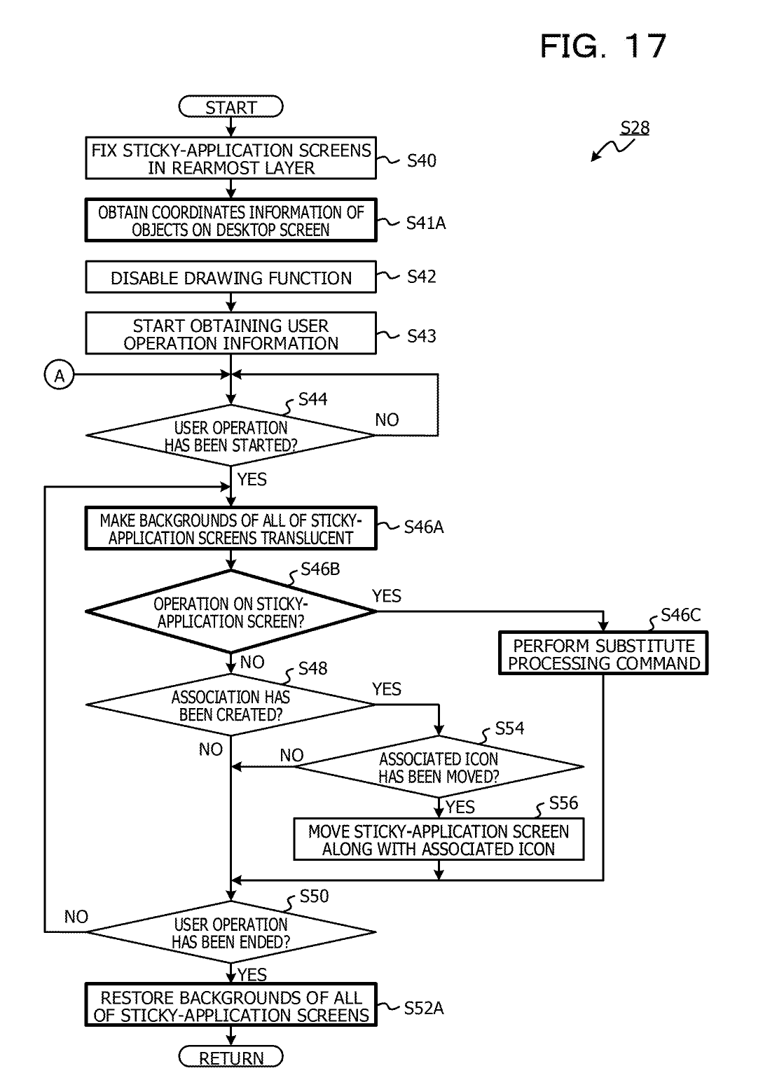

A second embodiment will be described in detail based on FIGS. 17 to 19. An information processing device according to the second embodiment has a configuration similar to that in the first embodiment, but the process (process in the fixing mode) of the processor 26 in the fixing mode is different from that in the first embodiment (FIG. 4).

The process in the fixing mode (S28) which is performed by the processor 26 will be described below according to the flowchart in FIG. 17 by referring to other drawings appropriately. In FIG. 17, a process different from that in FIG. 4 is illustrated with a bold frame, and an alphabet is added to the end of the step number.

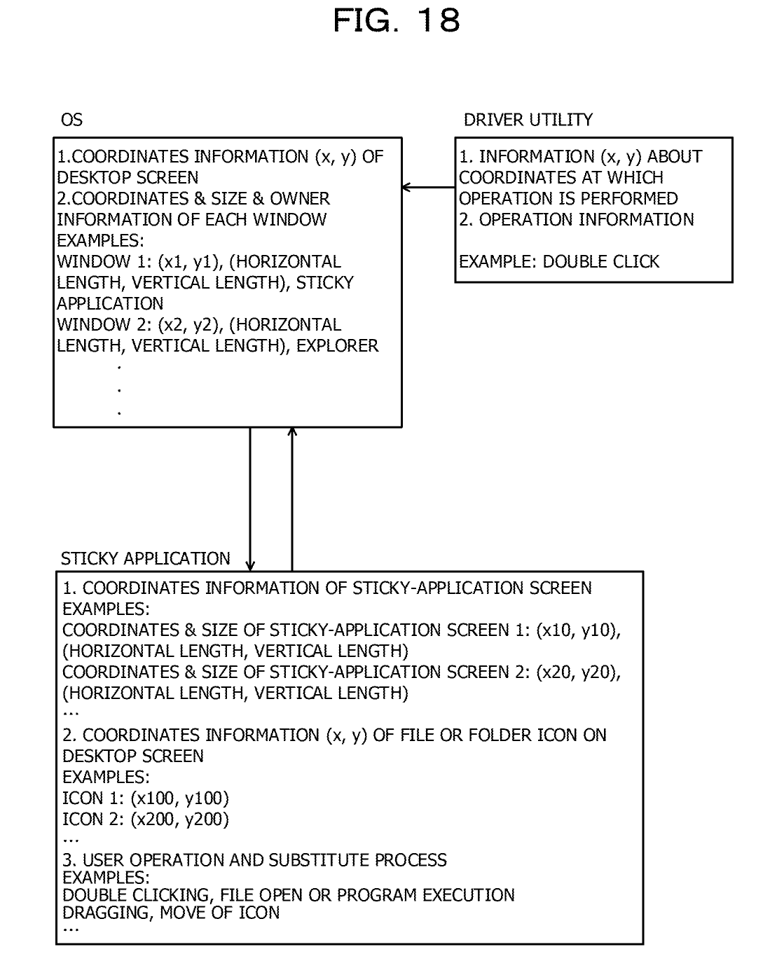

In the process in FIG. 17, in step S40, the processor 26 fixes the sticky-application screens in the rearmost layer. In the next step S41A, the processor 26 obtains coordinates information of objects on the desktop screen. Specifically, as illustrated in FIG. 18, coordinates information of the sticky-application screens and coordinates information of the icons on the desktop screen are obtained.

After the processes in steps S42 and S43 are performed in a way similar to that in the first embodiment, when a user operation has been started (S44: positive), the process proceeds to step S46A, and the processor 26 makes the backgrounds of all of the sticky-application screens translucent. The backgrounds of the sticky-application screens are made translucent because, while the sticky application 20 receives a user operation, the user may visually recognize the desktop screen on the back via the sticky-application screens.

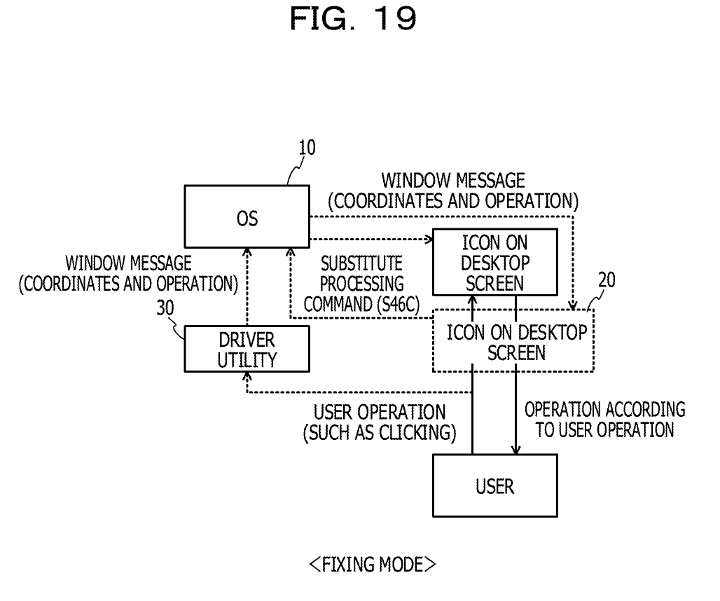

In step S46B, the processor 26 determines whether or not the user operation is an operation on a sticky-application screen. That is, the processor 26 determines whether or not an operation regarded as an operation for the display on the desktop screen has been received on a sticky-application screen. If the determination result in step S46B is positive, the processor 26 causes the process to proceed to step S46C, and performs a substitute command. As illustrated in the box for the sticky application in FIG. 18, the processor 26 holds information about a user operation and a substitute process. Therefore, as illustrated in FIG. 19, when the processor 26 obtains information (window message) indicating which operation has been performed at which coordinates on a sticky-application screen, via the driver utility 30 and the OS 10, the processor 26 transmits a substitute processing command to the OS 10 based on the information about a user operation and a substitute process in FIG. 18. For example, when the user double-clicks on a sticky-application screen, the processor 26 grasps, for example, that the user has operated an icon, based on the coordinates information of objects which is obtained in step S41A. The processor 26 transmits an instruction (such as the ShellExecute( ) function) to the OS 10 so that the grasped operation is performed. The OS 10 performs a process according to the substitute processing command. Thus, in the second embodiment, even when a sticky-application screen is present on an icon, an operation or the like on the icon may be performed without problems.

After step S46C, the process proceeds to step S50. In step S50, the processor 26 determines whether or not the user operation has been ended. If the determination result in step S50 is negative, the process returns back to step S46A. If the determination result in step S50 is positive, the process proceeds to step S52A. In step S52A, the backgrounds of all of the sticky-application screens are restored (the translucent state (S46A) is released). After that, the process proceeds to step S30 in FIG. 3.

If the determination result in step S46B is negative, that is, if the operation has not been performed on a sticky application, after the processes and determinations in steps S48, S54, and S56 are performed in a way similar to that in the first embodiment described above, the process proceeds to step S50.

The other processes are similar to those in the first embodiment. The second embodiment functions as a transferring unit which, when the processor 26 receives, on a sticky-application screen, an operation regarded as an operation for the display on the desktop screen, transfers information about the received operation (substitute processing command) to the OS 10.

As described above, according to the second embodiment, the processor 26 displays sticky-application screens through which the desktop screen is transparently viewed in the rearmost layer behind the other window screens in the fixing mode (S40). When the processor 26 receives, on a sticky-application screen, an operation regarded as an operation for the display on the desktop screen (S46B: positive), the processor 26 transfers information about the received operation (substitute processing command) to the OS 10 (S46C). Thus, in the second embodiment, similarly to the first embodiment, in the edit mode, input of characters and drawing of a figure on a sticky-application screen enable a memo or an arrangement for the desktop screen to be made, enabling the usability to be improved. In the fixing mode, an operation on an icon or the like is allowed to be performed on a sticky-application screen. Therefore, an operation on an icon or the like may be easily performed without being obstructed by sticky-application screens. Thus, work, such as clicking or dragging of an icon on the desktop screen, may be unaffected by sticky-application screens, enabling the usability to be improved.

### Third Embodiment

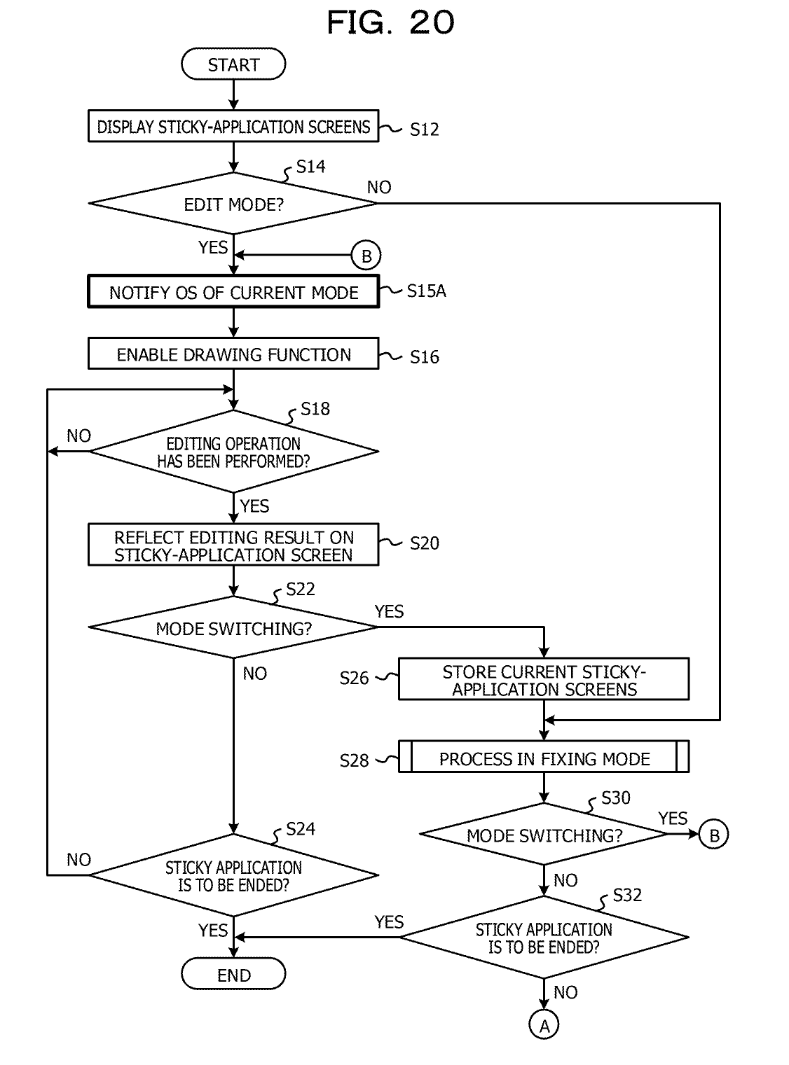

A third embodiment will be described in detail based on FIGS. 20 to 23.

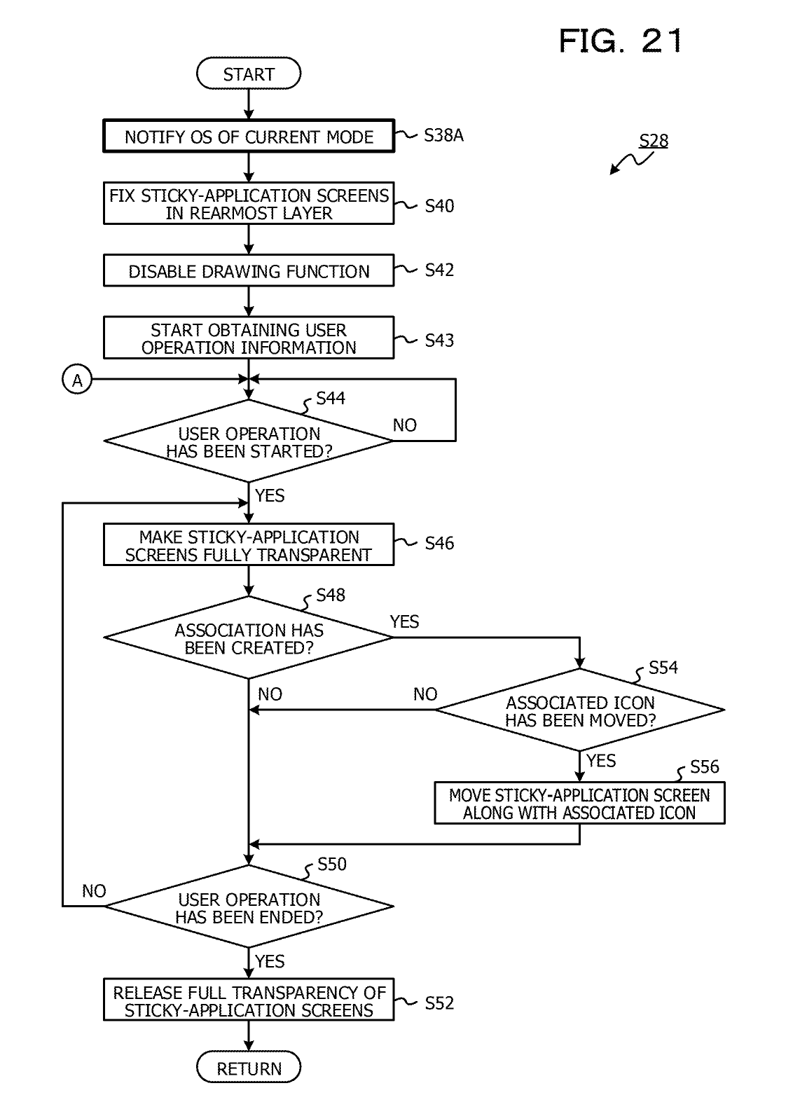

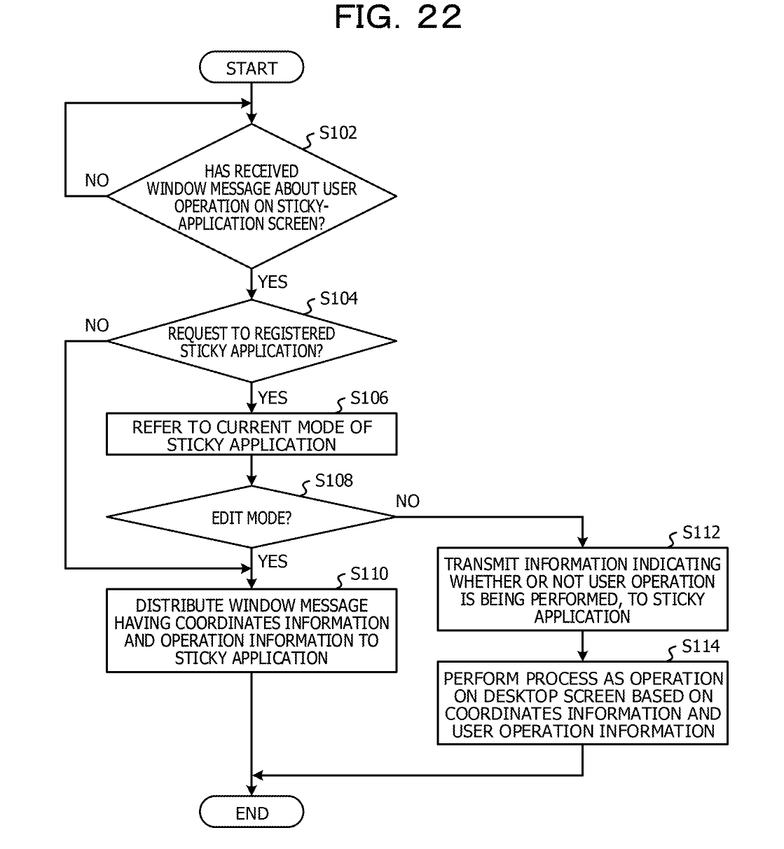

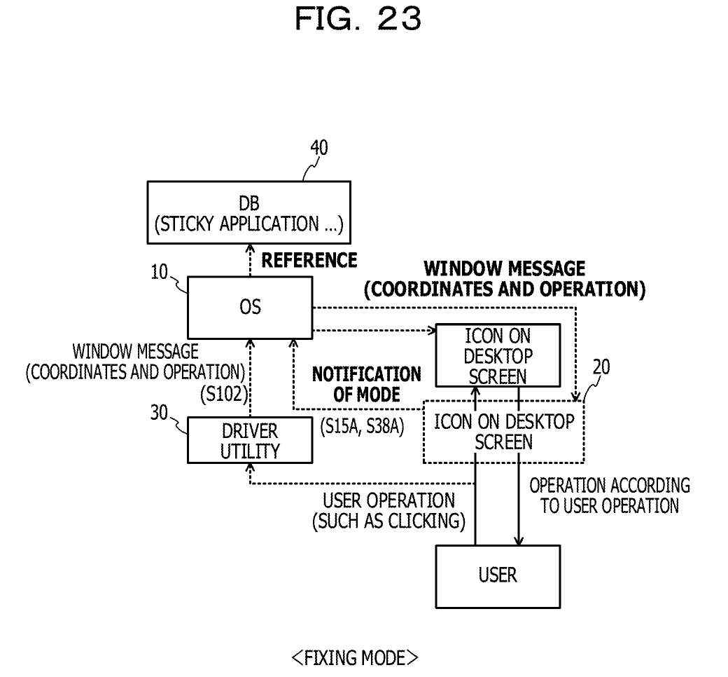

In the third embodiment, the sticky application 20 performs the process in FIGS. 20 and 21, and the OS 10 performs the process in FIG. 22. In the third embodiment, for example, applications (such as a sticky application) which are to be processed are registered in advance in a database 40 (see FIG. 23) of the OS 10.

The process in the flowchart in FIG. 20 corresponds to that in FIG. 3 in the first embodiment. The processor 26 of the sticky application 20 performs, in the process in FIG. 20, processes which are almost similar to those in FIG. 3, but which are different in that the process in step S15A which is illustrated with a bold frame is performed after step S14. In step S15A, the processor 26 notifies the OS 10 of the current mode which is set by the mode setting unit 24. In this case, in step S15A, since the determination result in step S14 is positive, the processor 26 notifies the OS 10 of information indicating that the current mode is the edit mode.

In contrast, in the process in the fixing mode (S28), the process is performed according to the flowchart in FIG. 21. In FIG. 21, in addition to the process in FIG. 4, step S38A illustrated with a bold frame is performed.

In step S38A in FIG. 21, similarly to step S15A in FIG. 20, the processor 26 notifies the OS of the current mode. In this example, since the fixing mode has been set, the processor 26 notifies the OS 10 of information indicating that the current mode is the fixing mode.

In contrast, the OS 10 performs the process according to the flowchart in FIG. 22. In the process in FIG. 22, in step S102, the OS 10 waits until a window message about a user operation on a sticky-application screen is received from the driver utility 30. That is, as illustrated in FIG. 23, the OS 10 waits until the driver utility 30 recognizes a user operation on a sticky-application screen and transmits a window message to the OS 10.

When the OS 10 receives the window message, the process proceeds to step S104, and the OS 10 determines whether or not the window message describes a request to an application registered in the database 40 (see FIG. 23). If the determination result in this step is negative, the process proceeds to step S110. If the determination result in this step is positive (if the sticky application has been registered in the database 40), the process proceeds to step S106.

When the process proceeds to step S106, the OS 10 refers to the current mode of the sticky application. In step S108, the OS 10 determines whether or not the current mode is the edit mode. If the determination result in step S108 is positive, the OS 10 distributes a window message having coordinates information and operation information to the sticky application 20. The sticky application 20 performs a process (for example, drawing of a figure or input of characters) based on the received window message (S20).

If the determination result in step S108 is negative, that is, if the fixing mode has been set, the process proceeds to step S112, and the OS 10 transmits information indicating whether or not a user operation is being performed, to the sticky application. In step S114, the OS 10 performs a process as an operation on the desktop screen based on the coordinates information and the user operation information. Thus, in the case where the fixing mode is set, when an icon is operated on a sticky-application screen, the operation is recognized as an operation on an icon, enabling an adequate process to be performed.

As described above, after the process in step S110 or S114 is performed, the entire process in FIG. 22 ends. While the information processing device 100 is operating, the process in FIG. 22 is repeatedly performed.

In the fixing mode, since a different window screen is displayed on the front of the sticky-application screens (see step S40), an operation for the different window screen may be processed in a usual manner.

As seen from the description made above, in the third embodiment, the OS 10 functions as a determining unit that receives an operation on the desktop screen, and that, when a sticky-application screen is present at a position at which the operation is performed, determines whether the mode of the sticky-application screen is the fixing mode or the edit mode. The OS 10 functions as a processor that, in the edit mode, transmits an operation on the desktop screen, to the sticky application 20 which displays sticky-application screens, and that, in the fixing mode, handles an operation on the desktop screen as an operation for the desktop screen.

As described above, according to the third embodiment, when the OS 10 receives an operation on the desktop screen, if a sticky-application screen through which the desktop screen is transparently displayed and which is displayed in the rearmost layer behind other window screens when the sticky-application screen is not being edited is present at the position at which the operation is performed, the OS 10 determines whether the sticky-application screen is in the edit mode or the fixing mode (S106, S108). If the sticky-application screen is in the edit mode, the OS 10 handles the operation as an operation for the sticky-application screen, and if the sticky-application screen is in the fixing mode, the OS 10 handles the operation as an operation for the desktop screen (S110, S114). Thus, in the third embodiment, similarly to the above-described embodiments, in the edit mode, input of characters and drawing of a figure on a sticky-application screen enable a memo or an arrangement for the desktop screen to be made, enabling the usability to be improved. In the fixing mode, an operation on an icon or the like is allowed to be performed on a sticky-application screen. Therefore, an operation on an icon or the like may be easily performed without being obstructed by sticky-application screens. Thus, work, such as clicking or dragging of an icon on the desktop screen, may be unaffected by sticky-application screens, enabling the usability to be improved.

In the above-described embodiments, the case in which the sticky application 20 may set the edit mode and the fixing mode is described. This is not limiting. For example, in existing word processor software and drawing software, the edit mode and the fixing mode may be set. For example, when the drawing software is set to the fixing mode, window screens are made transparent and are fixed in the rearmost layer on the desktop screen. Thus, information about drawing made by the drawing software may be viewed all the time, and an operation on the desktop screen may be achieved without being obstructed by window screens.

The above-described processing functions may be implemented by using a computer. In this case, a program describing processes of functions that are to be provided by the processing device is provided. The program is executed by a computer, whereby the processing functions are achieved on the computer. The program describing the processes may be recorded in a computer-readable recording medium (excluding a carrier wave).

When the program is distributed, for example, a portable recording medium, such as a digital versatile disc (DVD) or a compact disc read only memory (CD-ROM), in which the program is recorded is sold. Alternatively, the program may be stored in a storage device of a server computer, and the program may be transferred from the server computer to another computer via a network.

A computer which executes the program stores, for example, the program recorded in a portable recording medium or the program transferred from a server computer, in its own storage device. Then, the computer reads the program from its own storage device, and performs a process according to the program. The computer may directly read the program from the portable recording medium, and may perform a process according to the program. Every time a program is transferred from the server computer, the computer may sequentially perform processes according to the received program.

The above-described embodiments are preferable embodiments of the present disclosure. However, this is not limiting, and without departing from the gist of the present disclosure, various modifications may be made and embodied.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control method executed by a computer, the control method comprising:
while a sticky screen displayed on a desktop screen and for leaving at least one of a comment and a drawing on the desktop is not being edited,
displaying the sticky screen transparently;
displaying the sticky screen in a rearmost layer behind at least one window screen displayed on the desktop screen, the sticky screen being transparently displayed; and
when a first operation for a display region in which the sticky screen is displayed is detected, receiving information about the first operation as an operational instruction for the desktop screen corresponding to the display region.

2. The control method according to claim 1, further comprising:
receiving a second operation of associating the sticky screen with an operational member on the desktop screen; and
according to a reception of a move instruction to move the operational member, moving the sticky screen along with the operational member, the sticky screen being associated with the operational member having received the move instruction.

3. The control method according to claim 1, wherein the sticky screen includes a plurality of sticky screens.

4. The control method according to claim 1, further comprising:
while the sticky screen displayed on the desktop screen is not being edited, receiving the information about the first operation as the operational instruction for the desktop screen corresponding to the display region, by using a function for making a background of the sticky screen fully transparent.

5. The control method according to claim 4, wherein the function is a SetLayeredWindowAttributes function.

6. The control method according to claim 4, wherein the function is a function of, when an instruction to edit the sticky screen is transmitted, and where a third operation for the display region in which the sticky screen is displayed is detected, receiving the third operation as an operation for the sticky screen.

7. The control method according to claim 1, wherein the sticky screen is a screen for a sticky application.

8. A control method executed by a computer, the control method comprising:
when an operation is received on a desktop screen, determining whether or not a sticky screen for leaving at least one of a comment and a drawing on the desktop is present at a position at which the operation is performed, the sticky screen being displayed transparently and being displayed in a rearmost layer behind at least one window screen displayed on the desktop screen while the sticky screen is not being edited;
when the sticky screen is present, determining whether or not the sticky screen is being edited;
when the sticky screen is being edited, transmitting the operation on the desktop screen, to a screen display program for displaying the sticky screen; and
when the sticky screen is not being edited, and when the operation on a display region in which the sticky screen is displayed is detected, handling the operation as an operation for the desktop screen.

9. A control device comprising:
a memory; and
a processor coupled to the memory and configured to: while a sticky screen displayed on a desktop screen and for leaving at least one of a comment and a drawing on the desktop is not being edited,
display the sticky screen transparently,
display the sticky screen in a rearmost layer behind at least one window screen displayed on the desktop screen, the sticky screen being transparently displayed, and
when a first operation for a display region in which the sticky screen is displayed is detected, receive information about the first operation as an operational instruction for the desktop screen corresponding to the display region.

10. The control device according to claim 9, wherein the processor is configured to:
receive a second operation of associating the sticky screen with an operational member on the desktop screen, and
according to a reception of a move instruction to move the operational member, move the sticky screen along with the operational member, the sticky screen being associated with the operational member having received the move instruction.

11. The control device according to claim 9, wherein the sticky screen includes a plurality of sticky screens.

12. The control device according to claim 9, wherein the processor is configured to:
while the sticky screen displayed on the desktop screen is not being edited, receive the information about the first operation as an operational instruction for the desktop screen corresponding to the display region, by using a function for making a background of the sticky screen fully transparent.

13. The control device according to claim 12, wherein the function is a SetLayeredWindowAttributes function.

14. The control device according to claim 12, wherein the function is a function of, when an instruction to edit the sticky screen is transmitted, and where a third operation for the display region in which the sticky screen is displayed is detected, receiving the third operation as an operation for the sticky screen.

15. The control device according to claim 9, wherein the sticky screen is a screen for a sticky application.
